(19) United States
(12) Patent Application Publication
(10) Pub. No.: US 2006/0224945 A1
(43) Pub. Date: Oct. 5, 2006

(54) Operating method for computing devices

(76) Inventors: Soudy M. Khan, Palo Alto, CA (US); James J. Leftwich, Palo Alto, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/446,439

(22) Filed: Jun. 2, 2006

Related U.S. Application Data
(63) Continuation-in-part of application No. 10/229,860, filed on Aug. 27, 2002, now Pat. No. 7,058,904.

(51) Int. Cl. G06F 17/00

(52) U.S. Cl. 715/501.1

(57) ABSTRACT

A method for the easy input and operation of computing devices and electronic devices with limited space for input components. The method allows for a plurality of input functions using only two buttons in a method of contextual navigation. The two buttons provide numerous input functions which are continually graphically displayed such that the user can always discern the action which will occur when one or both buttons are depressed. Different functions occur with the pressing of each one of the buttons yielding two functions whereas pressing both buttons for a short period yields a third function. Additional utility is provided through the use of voice commands which may be associated data upon voice communication. A third button facilitates the entering and retrieval of voice data. Text may be entered using the method and is enhanced by prediction of input characters from a grid of characters selectable using the buttons.

This application is a continuation in part application from U.S. application Ser. No. 10,229,860 filed Aug. 27, 2002.

### BACKGROUND OF THE INVENTION

I. Field of the Invention

This invention relates to the operation and input of data to electronic devices and small or miniature computing devices. Such as personal digital assistants, watches, and other small form factor computing devices whose miniature form provides limited space for providing input means. In particular, this invention discloses a simple contextual navigation operating method for controlling data entry and display on electronic devices with limited space for input components and on small and miniature computing devices, both of which require a minimal number of buttons to accomplish a plurality of input and display operations. Using a unique combination of only two finger operated buttons, along with an optional but also preferred voice input button, the user is presented with an easy navigation and input system, for computing device having small surfaces for input components, which eliminates the need for keyboards and stylus-based entry which grows ever more cumbersome as the size of computing devices decrease.

II. Description of the Related Art

Small handheld and other computing devices requiring a generally small input device, represent one of the fastest growing sectors of the electronics industry. IDC predicts the demand for smart handheld devices alone will grow from 12.9 million units in 2000 to over 63.4 million by 2004, creating a worldwide market worth more than $26 billion. Automobile industry experts predict 50% of the 50 million vehicles produced each year will have in-vehicle telematics and multimedia systems by 2005. Further, as an example, more than 5 million U.S. consumers carry miniature computing devices secured to their key chains which will communicate with computers at gasoline service stations in order to speed up transaction times and take advantage of promotions.

The field of small and miniature computing devices, and devices with limited input space for a control set mounting surface is ever growing. Current devices include wrist-based computers, small cellular phones, MP3 players, USB engageable devices, PDAs, cameras, GPS units, car keys, automotive steering wheels, and military applications such as controls for use by soldiers having limited hand function.

However, unlike desktop and even laptop computers, miniature computing devices and many larger devices can have very limited input space in which to present data and to receive input from the user.

Additionally, many devices such as cars employ remote computers but have limited space for the input devices since they must be adjacent to the driver's hands. Further, with the continued shrinking of computing devices and increase in the memory carried by such devices, a computer the size of a wristwatch or car key with the computing power of a desktop computer is already a reality. As these devices shrink, and memory and processing in such devices grows, the input, retrieval, and display of data will continue to grow to increase as an ever more vexing problem. Further, while some devices may not shrink, the surface area for input to them may be very small.

Prior art attempts at solving this problem have included miniature keyboards and stylus based handwriting recognition. However, neither of these solutions is amendable to smaller form factor devices. Keyboards need to be large enough for adult fingers to reach every key without accidentally depressing adjacent keys to the desired key. Additional, shrinking display screens caused by physically shrinking computing devices make stylus-based input impractical, especially for those people who have trouble reading small type or hitting the correct point on a small screen with a very small stylus.

Other examples of prior art have dispensed with a full alphanumeric keyboard by providing a numeric keyboard in which multiple presses of a given numeric key to generate a specific letter. This type of operating method still imposes a significant size limitation on a device and tends to be slow to use. Furthermore, entry of punctuation and spaces, along with editing requires the user to remember the special functions of the numeric and other keys. However, because of the small size of the display and relatively large number of buttons, there is no way for these devices to show the effect of all of available buttons.

This usability problem is particularly important in miniature computing devices aimed at uses in telematics applications, key chains, and watches. These devices are typically aimed at broad consumer markets and thus require easy and intuitive usability by consumers with minimal experience with such devices and minimal interest in devoting substantial time to learning how to use such devices. One prior art solution is a stylus-based device utilizing handwriting recognition. However, as with keyboards, the need to provide sufficient writing space limits the minimum size of such a device. In addition, as devices become smaller, the stylus itself, which needs to be long enough to be securely held by the user, becomes a limitation on the minimal size of such devices. The stylus is also a liability in terms of the need to carry and secure them when not being used. Beyond these size and carrying limitations, stylus-based devices in the prior art have had problems with slow entry of data, and the need in some implementations for the user to learn a variant of the alphabet to allow the device to adequately distinguish between different characters.

An additional means of operating a computing device employed in the prior art is the wheel device that is rotated to operate. Some implementations include the ability to press the wheel to allow it to also act as a button. However, this potential solution also has its shortcomings. First, the wheel must be placed on the side of a device to be easily rotated, limiting use for applications such as watches where the device is worn rather than held. Further, the wheel mechanism is a liability in terms of device lifespan since the protruding portion of the wheel is easily damaged when dropped or bumped. Finally, while the use of a wheel to navigate through lists of data or functions is reasonably intuitive, the rotating wheel is unintuitive to use for other input operations. More importantly, because a wheel is easily rotated off the desired selection, use of the wheel requires that the user maintain eye contact with the device while using to ensure that desired navigation has occurred. This has obvious disadvantages in low light and driving applications.

What is needed to allow further miniaturization of computing devices is an operating method that does not place a substantial inherent limit on miniaturization and that requires only a minimal time investment to learn how to use.

### SUMMARY OF THE INVENTION

An operating method for computing devices where space is limited for input components should optimally use a minimum number of buttons or other input means to receive user input to allow the input device to remain small in size. A virtual display device such as an LCD display, should provide constant feedback to the user as to the changing function of these buttons, individually or in combination thereby providing the user with means of contextual navigation of the various screens and operations of the device. Furthermore, the optional addition of a means of voice input to supplement the minimal button set simplifies input of additional data while also enabling usage in situations, such as driving, with little physical or eye contact required. Additionally, with space available, additional buttons may be provided for additional functions such as text input or exiting the device or moving forward or backward on a visual screen.

The present invention addresses the problems described above by providing an operating method for miniature computing devices and for input to computing devices with limited space for the input components. In accordance with the invention, the device employs at least two buttons and a visual display device. Additional buttons may be provided depending on available space and are anticipated. A unique visual indicium is used to indicate each button or button combination on the visual display and the corresponding function of that button or combination. A different function of the device is thereby performed in response to pressing one or both of these buttons. An additional visual indicator may be used to signify that holding both buttons for a predetermined period of time results in the device performing a fourth function in response.

A further problem addressed by the present invention is navigation through large volumes of textual data that may be stored on a miniature computing device as in a personal contact or address database. While this data may be acquired by the miniature computing device by synchronization or download from another computer or sharing of virtual business cards, “vcards,” between different miniature computing devices, navigation through the resulting large database of data records can be quite tedious. Prior art methods provide wheels to scroll through data items, or repeated key presses to stimulate entry of letter data (e.g. pressing the “2” key of a telephone keypad 3 times to enter a “C”). However, these methods are obviously very tedious for large databases and are particularly poorly suited to telematic applications.

In the operating method of the present invention, an additional third button or third means to input other commands may be provided. The third means to input can be pushing the first two buttons at the same time in the basic embodiment used where space is confined. In a particularly preferred mode of the device, the third button would provide for voice commands to be input to enable storing of a vocal input in association with a displayed screen or data item and to enable direct navigation to that associated screen upon later input of substantially the same vocal input. Thus, for example, simply by stating a contact's name, the miniature computing device can jump immediately to displaying that persons contact information, or in an alternative embodiment, a map to that person's home. Additionally, if space allows, the third button might also provide an input means for simple actions such as backspacing in the software or exiting the device or other simple actions and such is anticipated.

Still further, employing the method and apparatus herein disclosed with a minimal number of input buttons, text may also be entered. The disclosed system would not dependent on having a “qwerty,” ISO12 (telephone), or any other type of traditional, physical (hard) keyboard. Instead, the operation that is assigned to any of the buttons during text entering will employ a navigation through a list of items on the display to activate individual items, and selection of the active item. In the text entry mode, the button or collected sequence of button actions used to navigation would be navigation buttons which in the two button system would be the first and second buttons. The button or collected sequence of button actions used to select items is the third means for entry, which in the simplest form of the device, is the two buttons pressed simultaneously. For text entry, the display has a region to display the text that has been entered, called the “text display.” There is also a soft keypad for entering the text, called the “keypad.” The soft keypad consists of a series of graphical keys in a display grid, with each key representing a character. One of the keys will be the active key, and it will be highlighted in some manner. The active key is said to be the location of the “keypad cursor.” By pressing the navigation keys, the user changes which key is the active key. When the user presses the select button, the character represented by the active key will be entered and subsequently displayed on the text display. Text selection can be enhanced using software to present predictive characters from the characters on the grid.

In this respect, before explaining at least one embodiment of the operating method and apparatus for input to electronic devices in detail, it is to be understood that the invention is not limited in its application to the details of construction, and to the arrangement of the components set forth in the following description or illustrated in the drawings. The invention is thus capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the input method and apparatus employed therewith is based, may readily be utilized as a basis for designing of other methods and components for carrying out the several purposes of the present invention. It is important, therefore, that the claims be regarded as including such equivalent construction insofar as they do not depart from the spirit and scope of the present invention.

### BRIEF DESCRIPTION OF THE DRAWINGS

The Features, objectives, and advantages of the invention will become more apparent from the detailed description set forth below when taken in conjunction with the drawings wherein like parts are identified with like reference numerals throughout and wherein:

FIG. 1 illustrates a simple miniature computing device utilizing the operating method according to the present invention.

FIG. 2 is a table that illustrates an embodiment of a set of visual indicia used to associate a button combination with a function.

FIG. 3 illustrates a device display according to an exemplary embodiment of the operating method of the present invention.

FIG. 4 illustrates another device display according to an exemplary embodiment of the operating method of the present invention.

FIG. 5 is a flow diagram showing an exemplary embodiment of the operating method according to the present navigation which provides stopwatch functionality.

FIG. 6 is a flow diagram showing an embodiment of navigation, including by voice, according to the present invention.

FIG. 7 depicts an exemplar computing device with a third button for additional input utilizing the operating method according to the present invention.

FIG. 8 depicts an embodiment of the device employing the two basic buttons and three additional buttons for simple input with the employment of predictive text.

FIG. 9 depicts the device of FIG. 8 additional text entered, and the different predictive text keys that result.

FIG. 10 depicts a two-button embodiment of the device adapted for engagement to a steering wheel with heads-up display.

### DETAILED DESCRIPTION OF THE INVENTION

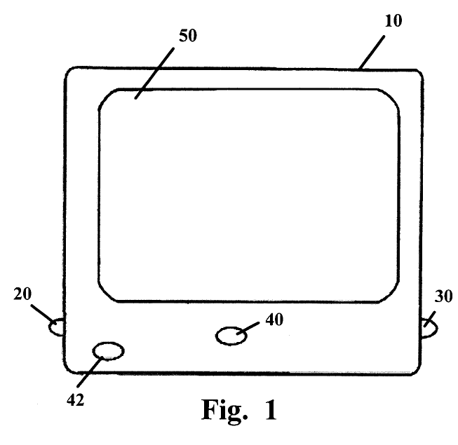

FIG. 1 illustrates a simple computing device 10 with limited space for input components which utilizes an operating method according to an embodiment of the present invention. Simple electronic switches operated by depressing a button are utilized in the current best embodiment because they can be easily recessed to prevent accidental activation and damage in day to day use. FIG. 1 depicts a typical small or miniature computing device 10 or a larger device with a small area for input components. The input for the computing device 10 has a plurality of button means for data input in the form of a first or left button 20, a second or right button 30, and in a current particularly preferred embodiment, a third button 40, or voice or other input, along with a means for visual display in the form of a liquid crystal display or LCD display 50. While the term button is employed herein to describe a depressable means for electronic switching, any finger activateable means for electronic switching is anticipated and consequently it need not be mechanical and could be a sensing device for touch or other means to initiate an electronic signal to the computing device that a switch or button has been activated. Sound or voice input may be provided by a conventional microphone 42 in the main body of the device 10 or communicating with the device 10 via a wired or wireless link. A unique visual indicum is used to provide contextual navigation to the user in that the current function or functions of each button or button combination is depicted on the visual display 50. Using this contextual navigation, the functionality of the device 10 is greatly increased because the user, which only two buttons, is given four different choices of action which are all depicted in the display 50. As depicted in figure two, along with the display of data on a screen or a change in screen data, a set of two circles are continually depicted on the display 50 for the user as a contextual guide to provide real time information on the input function that is accomplished by the pushing of one or a combination of both buttons 20 and 30. While depicted as circles, those skilled in the art can readily discern that other shapes might be used such as squares or triangles and such is anticipated. As best shown in FIG. 2, a graphical rendition of up to four different button depressions and their respective functions are related to the user by the showing of the circles filled or not, to indicate one or both buttons being depressed, along with brackets to indicate holding the buttons down for a longer period of time.

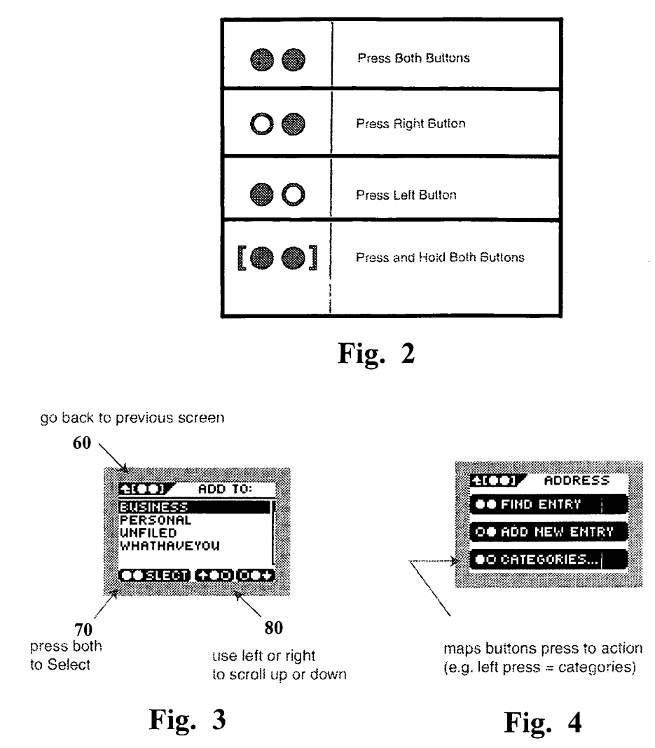

FIG. 3 shows the user of these visual indicia in an exemplary embodiment of an address categorization function. The visual indicia are shown in FIG. 3 in combination with letters or other symbols to show the result of input by the user of any of each button combination within the categorization function. The angled up arrow 60 along with the indicator for both buttons held down signify that the device will display the previous screen. The both buttons pressed indicator along with “SELECT” 70 signifies that pressing both buttons (without holding) will select the currently highlighted category and navigate to the resulting screen. The visual indicia for pressing either the left or right button along with an up 80 or down arrow 90 respectively, signifies navigation up or down through the list of categories. When one of the button combinations corresponding to a displayed visual indicium is activated by pressing the appropriate button(s), the miniature computing device performs the indicated function. Thus in the embodiment depicted in FIG. 3, when the business category is highlighted and both buttons are briefly simultaneously depressed, the computing device performs the related function, e.g. displaying a list of business related contacts.

The function performed by the various button combinations may change based on the context of overall activity that is being performed by the device. As is obvious to those skilled in the art, the exact function of any of the easily accomplished possible four inputs from the two buttons can change depending on the software employed and the use the herein disclosed contextual navigation using only two buttons and an optional voice input for a multitude of different software input is anticipated. FIG. 4 shows a related embodiment of the present invention wherein the same non-textual component of the visual indicia as in FIG. 3 is accompanied by different text to construct visual indicia for different functions. In FIG. 4, for instance, pressing both buttons performs a function related to finding an address entry rather than selecting a category as in FIG. 3. The present invention thus allows these different functions to be performed by the miniature computing device using the minimal control set of two buttons without requiring the user to learn anything beyond how, in this embodiment, the four simple visual indicia relate to the physical button controls of the device.

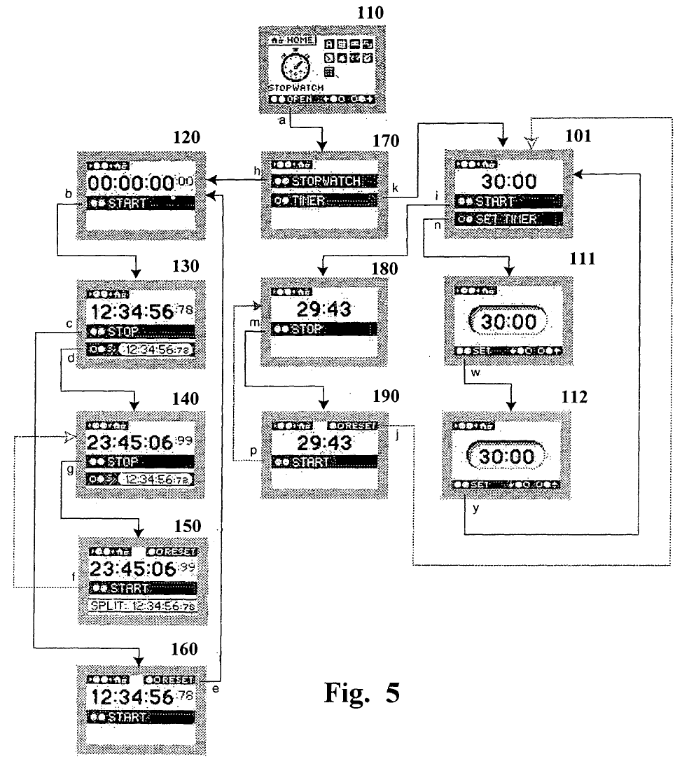

An embodiment of the operating method according to the present invention is illustrated by the flow diagram of FIG. 5. At step 110 in the diagram, the stopwatch function is displayed along with indicia for showing that pressing both buttons opens the stopwatch application, the left or right buttons pressed alone, navigate sequentially through other applications, e.g. an address book, a date book, etc. Following the activation of the stopwatch application by the user pressing both buttons simultaneously, the display depicted at 170 allows the user to press and hold both buttons to go back, press both quickly to perform the functions associated with the stopwatch activity, or press only the right button to perform simple timer functions. Pressing both buttons briefly causes the depiction of 120 to be displayed. At this screen, pressing both buttons causes the function related to starting the stopwatch to be performed and for the screen related to controlling the running stopwatch 130 to be performed. Pressing only the right button causes the stopwatch function relating to “split” time to be performed. At any time both buttons may be pressed and held to return to a “Home” screen, as is indicated by the visual indicium in the upper left corner of the display of step 120.

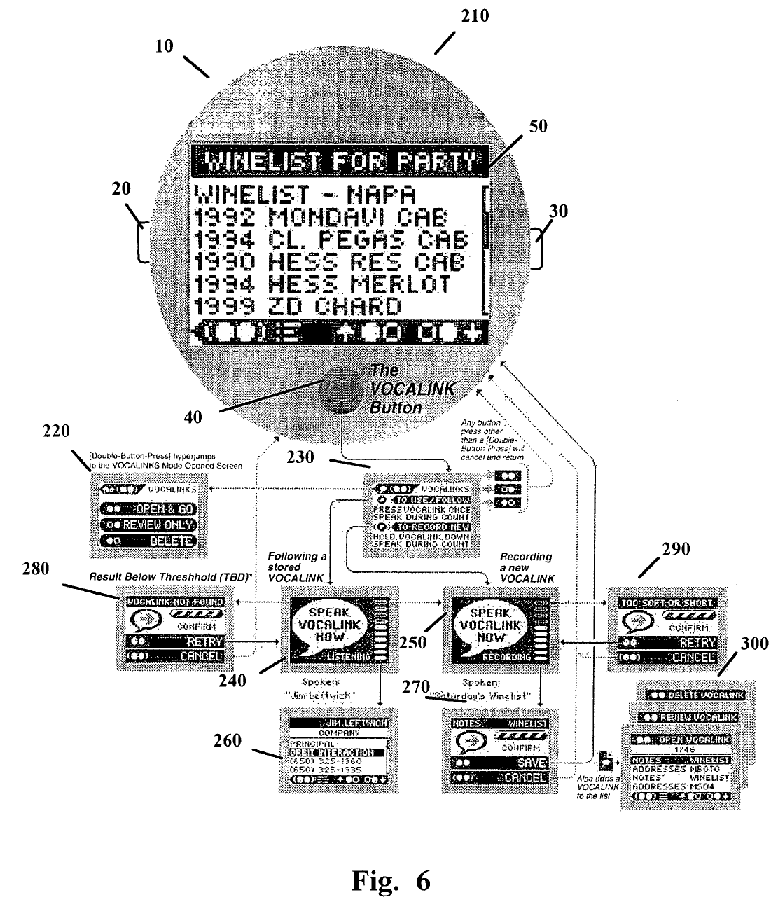

Some embodiments of the present operating method may also provide for navigation using the addition of voice input of voice commands to display a screen that has previously been associated with that specific voice input. FIG. 6 depicts a flow diagram illustrating an embodiment of the operating method of the present invention which includes these additional voice input association functions. As an example of how a voice input can be added to the simple two button operating system to further its utility, at the screen depicted at 210, a wine list is displayed, along with the visual indicia for navigation through the list using the elements of the operating method described above. Upon a press of a third button 40, the function is performed which displays the vocalinks instruction screen 230. Holding down the third button 40 causes the function for following a vocalink to be performed. This results in the display at 240 requesting the user to input the vocalink to be followed. The embodiment illustrated in 240 also shows a countdown of time via a graphical indicator, but other embodiments may use numeric indicia, audible feedback such as a tone, or any similar means to indicate to the user that the miniature computing device is awaiting vocal input. The required vocal input may be obtained, for example, via an electronic microphone in the housing of the miniature computing device or by one connected through a wire or set of wires, or wirelessly using an RF mechanism such as Bluetooth where the user simply states a voice command which is communicated to the device 10.

The device 10 may accept the voice input in conjunction with depression of this third button 40, for a determined period after depression of this third button 40, or for a time period following depression of the third button 40 that is substantially equal to the depression time it was held. Or combinations of this timing could be combined to allow for vocal input and then confirmation or search activation for a match between the input voice command and a particular page of data. After the vocal input is complete, the vocal command so input is processed. One embodiment of the vocal input processing is voice recognition wherein the voice input is converted to corresponding text or phonetic data or a digital representation of the voice command and stored in the memory of the device 10. In other embodiments, other representations of the vocal input data may be stored, such as minimally processed PCM data or compressed data using the voice coding techniques utilized by mobile telephones. The voice command is thus converted to a format that may be stored in memory of the device 10 and associated with a display page for later retrieval when the voice command is repeated and input.

As further depicted in FIG. 6, in an embodiment of the device having software that stores personal information in a database, the vocal input in the form of the communicated voice command is compared to other stored vocal inputs and matched to that of a person. If no match is found, a function may be performed to provide the user with an opportunity to retry vocal entry 280. In the example shown in FIG. 6, the voice input matches that of one previously associated with a personal contact entry of that person. Following a match, the miniature computing device displays the screen with the selected contact 260.

When the voice entry function is selected at 230, the recording function is performed resulting in the display 250. The voice input is received here as was described previously. When voice input is completed, a final confirmation 270 is displayed. If the save function is selected, the voice input is stored in memory and associated with a particular display 210. This vocalink may be traversed at a later time following the method as shown in 230 and 240 wherein the user would simply repeat entering the voice command that was associated earlier with a particular entry and thus a user may “jump” to a particular display screen which is associated to the particular voice command that has been stored in memory and associated with that particular page of data.

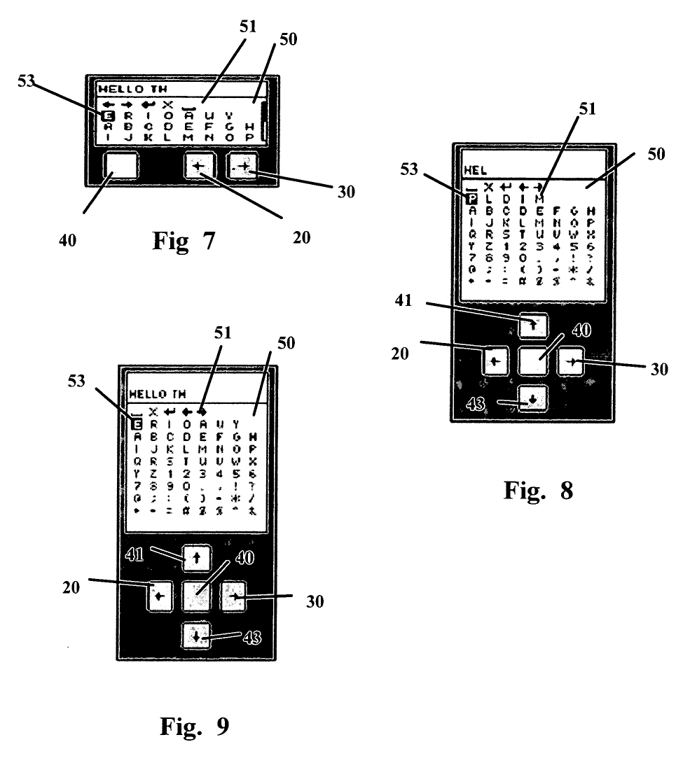

FIGS. 7-9 depict electronic devices employing one or more additional input buttons from the two employed in the simplest version of the device. These embodiments would function substantially similar when employed by a user using only two of the buttons in the aforementioned fashion. However, voice input as disclosed above may be employed using a third button and in a particularly preferred method employing one or more buttons where space allows, text may be input into the device.

When employed for text input on a computing device which has limited space for input components, the operation that is assigned to the buttons is navigation through a list of items on the display to activate individual items, and selection of the active item. The buttons or collected sequence of button actions used to navigate are called navigation buttons, which would generally be the first and second buttons. The button or collected sequence of button actions used to select items is called the select button, which would be the third means for input of either both buttons simultaneously, or a third button, or a voice command.

For text entry, the display has a region to display the text that has been entered, called the “text display.” There is also a soft keypad on a visual grid for entering the text. The soft keypad consists of a series of graphical keys on the grid with each key representing a character. One of the keys will be the active key, and it will be highlighted in some manner. The active key is said to be the location of the “keypad cursor.”

By pressing the navigation keys, the user can change which key is active and enhanced by the curser. When the user presses the select button or in the two button mode of the device, both buttons simultaneously, the character represented by the active key will be entered and subsequently displayed on the text display.

The keys in a soft keypad are arranged in a line or grid. Typing is typically very slow in this type of system because of the time it takes to find the proper key and to move the keypad cursor to it. However, the method herein in a particularly preferred mode, would employ predictive text to address both of these issues.

Using predictive text input, the keypad is arranged to have a fixed set of characters that will be used for data entry. Input will work with a minimum number of keys or may include a set of control keys, such as backspace, forward and back arrows, the shift key, and enter and space keys. The fixed keyboard will also consist of the letters of the alphabet, preferably arranged sequentially in alphabetical order, and the digits and punctuation symbols.

The keypad also has a group of “predictive” letters or symbols. This set of keys changes based on the previous characters that have been entered. The total number of characters should be small enough so the user can quickly and easily scan the keys to see if the desired key is present. The group of predictive letters is arranged in a preferred location, in such a way that the easiest keys to use are the predictive keys. The user also always has the option of using the fixed keys.

The predictive keys will be determined based on the most probable next character to type based on the previous characters typed. The most probable character will be the fastest character to find and select. As the characters are less probable, they are in a less favorable position. There are a total of N predictive keys. If the user wants to enter a character that is not in the top N most probable characters, he will have to enter that character from the set of fixed keys.

For computing devices sporting larger displays, an additional set of keys can be used for word completion. These keys will each include an entire word. As the user enters characters, the most probable words based on the previous typed characters will appear in these keys. Selecting one of these keys will enter the necessary letters to complete the word.

In a method for determining the probability for a character to be the next character typed, a list of words, or other groups of characters, is used with a weight value for each word, which is based on the frequency of use of that word for the relevant application. The software on the device keeps track of the letters that have been entered since the start of the current word. As each of these letters is typed, the subset of words from the list consistent with the entered letters is created. The likelihood of a given letter being typed next is determined from the number of times that letter appears next in the subset of consistent words combined with the weight of each of those words.

The following examples demonstrate a keypad with predictive text for systems with three and five buttons.

The device as shown in FIG. 7 shows an example device with three buttons which would operate using the contextual navigation noted above and has substantially the same input components as FIG. 1, including a first button 20, a second button 30, a third button 40, and an LCD display 50. The first and second buttons move the cursor forward and backward through the grid 51 sequentially, with the cursor 53 wrapping to the next line after it scrolls to the end of one line. The character grid 51 has the same keys as the five-button example of FIGS. 8-9, except the control characters are arranged in a slightly different order because of difference in navigation. Also, since the LCD display 50 is smaller than the dimension of the entire soft keypad in the grid 51, so it scrolls as needed to display the active key. The third button 40 would act as a select button once the curser is navigated to the desired character in the grid 51 or predicted character. As with the contextual navigation described in FIG. 1, a similar text input system can be employed using only two buttons rather than three, whereas pressing both buttons simultaneously acts as a virtual third button 40 or enter-button. However, if space is available the third button 40 for some users unable to press the first and second buttons simultaneously, may be considered easier.

As shown in FIGS. 8-9, where sufficient space is available for extra input buttons, a five-button device is depicted. The five-button device consists of four arrow buttons of a left or first button 20, a right or second button 40, a third button 40 employed for a select key, and two additional buttons 41 and 43 for easier up and down contextual navigation. The keypad is arranged as a grid 51, and the arrows move the keypad cursor in the associated direction on the grid 51 in the aforementioned fashion.

The characters available for input are arranged in the grid 51 with the first row of letters being control characters, the second row being the predictive characters, and the rest of the rows being fixed character keys. There generally are a maximum of eight predictive keys. However as shown in FIG. 8, there are only 5 characters listed as next possible buttons.

During use of the method herein for the embodiment with five buttons, each time after the user selects a character, the cursor jumps to the start of the predictive row. This makes the first of the predictive characters the easiest key to reach. After the initial characters, the user should almost always be able to select the next character from the group displayed on the predictive row. This minimizes the number of letters the user must scan to find the desired next letter and the time it takes to reach that letter. At the same time, the user can always select from the keys in the fixed keypad, which are in known locations.

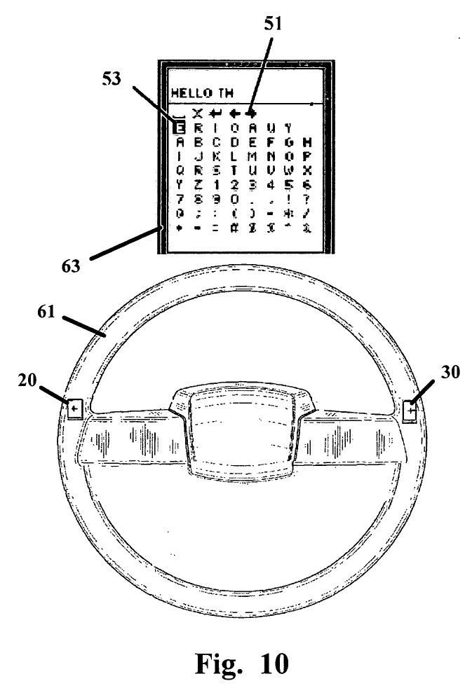

As an exemplar of the use of the control method for electronic devices where space for input components is limited, FIG. 10 depicts a two-button embodiment of the device adapted for engagement to a steering wheel 61 with heads-up display 63 providing the display that an LCD would provide in aforementioned embodiments. This two-button embodiment would have all the aforementioned functions and methods of operation for text input, navigation, or control of a computing or electronic device where space for input is limited. Here as shown, first button 20 and second button 30 are mounted on the very small surface of the steering wheel 61 in a position adapted to allow engagement by the thumbs of a user without taking their hands from the steering wheel 61. Input would be in the aforementioned fashion of any of the aforementioned types of input and control. This embodiment would be especially helpful to drivers wishing to control aspects of a heads-up display 63 or input text to designate a destination, or sending email from the auto's onboard computer, or any other function where control of an electronic device is desired but space is limited. With the provision of the heads-up display 63 in place of the LCD display 50 the user need only look at the display while controlling the functions of the electronic device based on what is viewed. A third button 40 could be added adjacent to one of the other buttons, and for a particularly favored version of this embodiment, the addition of a means of voice input to supplement the minimal two or three-button control set, would help simplify input of additional data while also enabling other commands to be made once the input of text or other input from the button set is finished. For example, a driver while driving could input a text message, read it on the heads up display 63 and then send it by voice command or by use of the appropriate button from the button set giving the user more options in a difficult use situation.

Of course virtually any electronic device where a small footprint is desireable, or required for the input components, may be controlled by the method herein using minimum button sets, and such that would occur to those skilled in the art are anticipated. Further, while all of the fundamental characteristics and features of the operating method for computing devices with limited input buttons have been described herein, with reference to particular embodiments thereof, a latitude of modification, various changes and substitutions are intended in the foregoing disclosure and it will be apparent that in some instance, some features of the invention will be employed without a corresponding use of other features without departing from the scope of this invention as set forth. It should be understood that such substitutions, modifications, and variations may be made by those skilled in the art without departing from the spirit or scope of the invention. Consequently, all such modifications and variations are included within the scope of the invention defined herein.

What is claimed is:

1. In combination with a computing device having a processor, memory, software, at least two button means for input, a means for receiving a voice input, at least one stored voice command, and a visual display device, the method comprising:
providing a first visual indicator on the visual display device which indicates a first function that is to be performed by the computing device if only a first button is pressed;
providing a second visual indicator on the visual display device which indicates a second function that is to be performed by the computing device if only a second button is pressed;
providing a third visual indicator on the visual display device which indicates a third function that is to be performed by the computing device if said first button and said second button are both pressed simultaneously;
sensing which buttons are pressed;
performing the first function on the computing device if the first button is pressed;
performing the second function on the computing device if the second button is pressed;
performing the third function on the computing device if the first button and the second button are both pressed simultaneously; and
performing a fourth function if said voice command is received by said means for voice input.

2. In combination with the method of claim 1 additionally having a plurality of stored screen displays for display on said visual display device which are associated with a plurality of said voice commands:
receiving said voice command on said means for voice input;
discerning a stored screen display, from said plurality of stored screen displays, which is associated with said voice command so received; and
displaying said stored screen display on said visual display device.

3. In combination with a computing device having a processor, memory, software, at least two button means for input engaged upon a vehicle steering wheel, and a visual display device, the method comprising:
providing a first visual indicator on the visual display device which indicates a first function that is to be performed by the computing device if only a first button is pressed;
providing a second visual indicator on the visual display device which indicates a second function that is to be performed by the computing device if only a second button is pressed;
providing a third visual indicator on the visual display device which indicates a third function that is to be performed by the computing device if said first button and said second button are both pressed simultaneously;
sensing which buttons are pressed;
performing the first function on the computing device if the first button is pressed;
performing the second function on the computing device if the second button is pressed;
performing the third function on the computing device if the first button and the second button are both pressed simultaneously; and
whereby said computing device can be controlled by a user while holding said steering wheel.

4. The method of claim 3 additionally combining a means for receiving a voice input, at least one stored voice command, and the additional step of:
performing a fourth function if said voice command is received by said means for voice input.

5. In combination with a computing device having a processor, memory, software, at least two button means for input, a visual display device, a grid of characters in a character screen depictable on said display device, and a curser for designating individual of said characters, the method comprising:
providing a first visual indicator on the visual display device which indicates a first direction of motion for said curser that is to be performed by the computing device if only a first button is pressed;
providing a second visual indicator on the visual display device which indicates a second direction of motion of said curser that is to be performed by the computing device if only a second button is pressed;
providing a third visual indicator on the visual display device which indicates a third function of character that is to be performed by the computing device if said first button and said second button are both pressed simultaneously;
sensing which buttons are pressed;
performing the first function on the computing device if the first button is pressed;
performing the second function on the computing device if the second button is pressed; and
performing the third function on the computing device if the first button and the second button are both pressed simultaneously, whereby text can be input to said computing device by moving said curser with said first and second functions and designating characters of said text with said third function.

6. The method of claim 5 additionally combining a means for receiving a voice input, at least one stored voice command, and the additional step of:
performing a fourth function if said voice command is received by said means for voice input.

7. The method of claim 5 additionally combining a means for receiving a voice input, at least one stored voice command, and the additional step of:
associating said voice command with a particular display stored in memory of said miniature computing device;
storing the association between said voice command and said particular display screen in said memory; and
moving directly to said particular display screen upon subsequent input of said voice command to said miniature computing device.

8. The method of claim 5 wherein a third button means for input is provided, the additional step of:
providing a visual indicator on the visual display device which indicates a fourth function that can be performed by the computing device if said third button is depressed; and
performing the fourth function on the computing device if the fourth button is depressed.

9. The method of claim 6 wherein a third button means for input is provided, the additional step of:
providing a visual indicator on the visual display device which indicates a fifth function that can be performed by the computing device if said third button is depressed; and
performing the fifth function on the computing device if the fourth button is depressed.

10. The method of claim 5 wherein said at least two button means for input is engaged to a mounting surface adapted to hold it, said mounting surface being one from a group of mounting surfaces including, a vehicle steering wheel, the surface of an MP3 player, the surface of a PDA, and the surface of a watch, the surface of a wrist-based computer, the surface of a small cellular phone, the surface of a camera, the surface of a GPS unit, a side surface of a car key.

11. The method of claim 6 wherein said at least two button means for input is engaged to a mounting surface adapted to hold it, said mounting surface being one from a group of mounting surfaces including, a vehicle steering wheel, the surface of an MP3 player, the surface of a PDA, and the surface of a watch, the surface of a wrist-based computer, the surface of a small cellular phone, the surface of a camera, the surface of a GPS unit, a side surface of a car key.

12. The method of claim 7 wherein said at least two button means for input is engaged to a mounting surface adapted to hold it, said mounting surface being one from a group of mounting surfaces including, a vehicle steering wheel, the surface of an MP3 player, the surface of a PDA, and the surface of a watch, the surface of a wrist-based computer, the surface of a small cellular phone, the surface of a camera, the surface of a GPS unit, a side surface of a car key.

13. The method of claim 8 wherein said at least two button means for input is engaged to a mounting surface adapted to hold it, said mounting surface being one from a group of mounting surfaces including, a vehicle steering wheel, the surface of an MP3 player, the surface of a PDA, and the surface of a watch, the surface of a wrist-based computer, the surface of a small cellular phone, the surface of a camera, the surface of a GPS unit, a side surface of a car key.

14. The method of claim 5 comprising the additional steps of:
employing text predicting software on said computing device to determine a predicted character from said character screen based on preceding of said characters selected; and
depicting a predicted character for selection on said visual display device.

15. The method of claim 14 comprising the additional steps of
employing said text predicting software to maintain a subset of words formed from said characters in said memory; and
determining said predicted character based on the number of times it appears in said subset of words.

16. The method of claim 15 comprising the additional steps of
weighting each word in said subset of words with a predictive factor; and
increasing occurrences of characters in said each word of said subset of words by a multiple of said predictive factor, whereby characters in said subset of words with higher predictive factors are more likely to be depicted as said predicted character.

17. The method of claim 1 comprising the additional steps of:
providing a fourth visual indicator on the visual display device which indicates a fourth function that is to be performed by the computing device if said first button and said second button are both pressed simultaneously for a determined time duration; and
performing the fourth function on the computing device if the first button is pressed simultaneously with the second button for said determined time duration.

18. The method of claim 5 comprising the additional steps of:
providing a fourth visual indicator on the visual display device which indicates a fourth function that is to be performed by the computing device if said first button and said second button are both pressed simultaneously for a determined time duration; and
performing the fourth function on the computing device if the first button is pressed simultaneously with the second button for said determined time duration.
